(19) United States
(12) Patent Application Publication
(10) Pub. No.: US 2007/0193825 A1
(43) Pub. Date: Aug. 23, 2007

(54) Lighted step

(76) Inventors: Travis Liermann, Naples, ID (US); Laree Liermann, Naples, ID (US); Bradley Navarro, Bonners Ferry, ID (US); Kelly Navarro, Bonners Ferry, ID (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/706,810

(22) Filed: Feb. 15, 2007

Related U.S. Application Data
(60) Provisional application No. 60/773,611, filed on Feb. 15, 2006.

(51) Int. Cl. E04G 1/00; E06C 5/44

(52) U.S. Cl. 182/20; 182/18

(57) ABSTRACT

A tree-step system includes a fastener configured to be coupled to a vertical member, and a step component including a body, a weight-bearing member coupled to the body, and a light source associated with the weight-bearing member, wherein the light source indicates a location of the weight-bearing member.

### RELATED APPLICATIONS

The present application claims priority of U.S. Provisional Patent Application No. 60/773,611 titled “Lighted Step” filed on Feb. 15, 2006, which application is incorporated herein by reference in its entirety.

### BACKGROUND

For many types of game, an optimal hunting posture is a position elevated above the ground. Such a position may be obtained within a specially constructed hunting structure or blind which has an elevated platform and a secure ladder for ascent. However, these fabricated hunting blinds have the disadvantage that they are costly, time-consuming to erect, and strictly limited to one hunting location. Furthermore, erection of such structures on public lands can be problematic.

Consequently, hunters will commonly climb trees to achieve a desired overhead position with respect to the targeted game. Occasionally, a tree will be provided with sturdy branches at optimal locations to permit the hunter to reach an elevated position. However, it is generally unlikely that a tree having branches at all the necessary locations will also be positioned within the forest at precisely the location the hunter wishes to employ. Furthermore, branches may be in various stages of decay not immediately apparent to the climber, making use of naturally occurring branches as climbing aids potentially hazardous.

Portable mechanical trees steps have been developed to assist the hunter in climbing any tree with a secure footing. One common tree-step type has a block with a protruding screw which may be inserted into the tree and rotated to drive the screw into a secure attachment. Other trees steps require some type of drilling before attachment of the step.

Often, hunting opportunities peak during dusk hours. That is, wildlife is often most active as the sun goes down and the animals leave their cover to graze. Consequently, dedicated hunters often find themselves in their elevated positions after nightfall. After nightfall, hunters of a wide range of ages must leave a tree stand or other elevated position in dimly lit conditions.

### SUMMARY

According to one exemplary embodiment, the present exemplary system and method provides for a lighted step configured to facilitate climbing up and/or down an object or surface in low light conditions. According to one exemplary embodiment, a light source indicates the location of a member capable of supporting a user's weight. The exemplary system includes a fastener to secure the system to the location of the user's choice. Additionally, some embodiments include a sensing element to activate the light source when a previously specified condition is detected.

According to one exemplary embodiment, a tree-step system includes a fastener configured to be coupled to a vertical member, and a step component including a body, a weight-bearing member coupled to the body, and a light source associated with the weight-bearing member, wherein the light source indicates a location of the weight-bearing member.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1A is an assembled view of a lighted step including a detachable fastening system, according to one exemplary embodiment.

FIG. 1B is an unassembled view of a lighted step including a detachable fastening system, according to one exemplary embodiment.

FIG. 2 is a perspective view illustrating a lighted step configuration including a sensing element, according to one exemplary embodiment.

FIG. 3 is a flowchart illustrating a method of installing and operating a lighted step, according to one exemplary embodiment.

FIG. 4 is a flowchart illustrating another method of installing and operating a lighted step with sensing capabilities, according to one exemplary embodiment.

Throughout the drawings, identical reference numbers designate similar, but not necessarily identical, elements.

### DETAILED DESCRIPTION

The present specification discloses an exemplary system and method for illuminating a path to an elevated viewing location. According to one exemplary embodiment disclosed herein, a weight-bearing step system is fastened to an object or surface. Furthermore, according to the present exemplary system and method, the weight-bearing step system includes an illuminated component to aid the user in ascending to or descending from an elevated position. Further details of the present exemplary lighted step will be provided below.

Before particular embodiments of the present exemplary systems and methods are disclosed and described, it is to be understood that the present systems and methods are not limited to the particular processes and materials disclosed herein as such may vary to some degree. It is also to be understood that the terminology used herein is used for the purpose of describing particular embodiments only and is not intended to be limiting, as the scope of the present system and method will be defined only by the appended claims and equivalents thereof.

As used in the present specification and in the appended claims, the term “weight-bearing member” is meant to be understood broadly as including, but not being specifically limited to, any support or other structural member capable of bearing weight without failure or becoming otherwise unstable. However, the term weight-bearing member does not imply that the member must constantly support weight when installed.

As used in the present specification and in the appended claims, the term “target condition” is meant to be interpreted as including a state or situation characterized by any number of environmental conditions or parameters determined as a measure of time or date, delay or waiting period, light intensity, temperature, humidity, pressure, or any change in these or other variables that identify a determined condition.

In the following description, for purposes of explanation, numerous specific details are set forth in order to provide a thorough understanding of the present system and method for lighted steps. It will be apparent, however, to one skilled in the art, that the present system and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Exemplary System

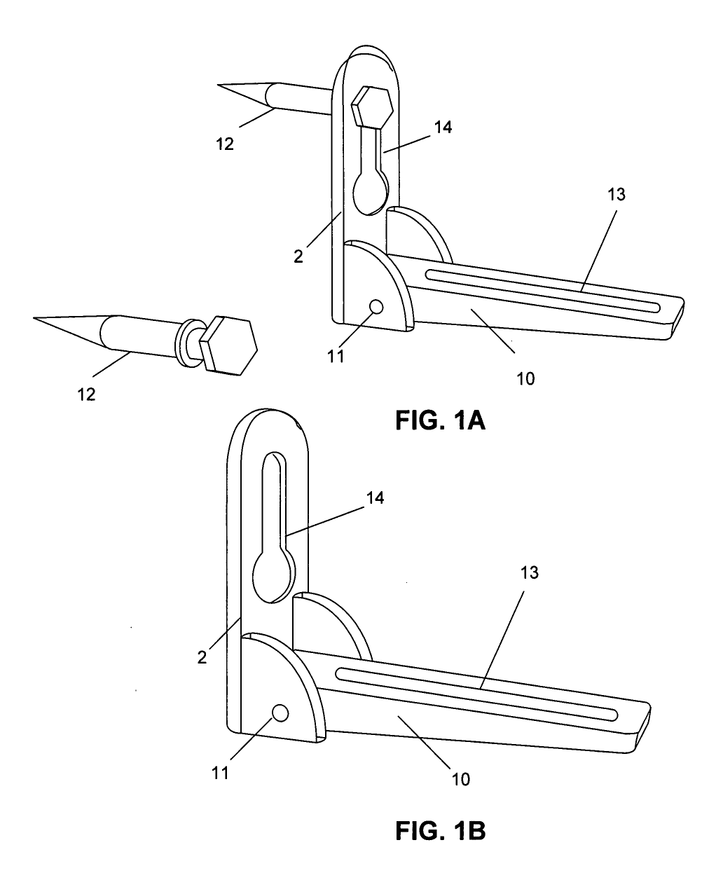

FIG. 1A and FIG. 1B illustrate an assembled and an unassembled lighted step configuration, respectively, according to one exemplary embodiment. As illustrated in FIGS. 1A and 1B, the present system includes a main body (2) configured to be fastened to a tree or other object. As shown, the main body includes a connection interface (14) formed therein. Additionally, as illustrated in FIGS. 1A and 1B, a weight-bearing member (10) may be pivotably connected to the main body (2) and extends from the main body (2) of the system, thereby providing both stability and support for the present exemplary step configuration. Moreover, as illustrated, alight source (13) is disposed in the weight-bearing member (10) in order to provide light to a descending or ascending user. Additionally, as illustrated in the exemplary figures, a fastener (12) can form a portion of the exemplary configuration. According to one exemplary embodiment, the illustrated structure may be strong enough to support a person's entire weight or exceed an average person's weight. This member may be implemented as a step, a rung, a platform, a substantially horizontal member of any size, or any other non-horizontal member that a person could grasp, step on, lean on, or otherwise derive support. Further details of each component of the present exemplary system will be provided below.

As illustrated, the present exemplary system includes a main body (2) configured to provide support to the present exemplary system. While the present exemplary main body (2) is illustrated as a rectangular shape, the main body (2) may be any number of shapes configured to provide attachment to the remaining portions of the present exemplary system. Furthermore, the present exemplary main body (2) may be made of a supportive structural material sufficiently strong to support the remaining portions of the exemplary system. For example, according to one exemplary embodiment, the main body (2) of the present system may be formed of one or more of a metal, a structural plastic, a composite, wood, or any combination thereof.

Additionally, as illustrated in FIGS. 1A and 1B, a connection interface (14) is formed in, or is otherwise associated with the main body (2). The connection interface (14) is configured to facilitate coupling of the fastener (12) to the main body (2). The connection interface (14) may assume any form that allows the main body (2) to detach from the fastener (12) and reattach securely. According to one exemplary embodiment, the connection interface (14) may be an orifice formed in the main body (2) such as a key-hole orifice.

In addition, at least one fastener (12) is configured to couple the system to an object or surface, such as a tree, pole, rock face, hill, fence, or wall. Suitable fasteners (12) include, but are not limited to, screws, bolts, nails, ropes, wires, cables, straps, and clasps. A fastener (12) may or may not be permanently coupled to the body, and in some embodiments may be unfastened and re-attached at different locations as often as a user desires.

As illustrated in FIGS. 1A and 1B, the weight-bearing member (10) is coupled to the main body. According to one exemplary embodiment, the weight-bearing member (10) is formed of the same material as the main body (2). Alternatively, the weight-bearing member (10) may be formed of a material that is dissimilar from the main body (2). As illustrated, the weight-bearing member (10) may include a planar surface to provide for the support of a user. Additionally, the weight-bearing member (10) may include a surface finish or pattern configured to enhance the friction on the weight-bearing member.

In another exemplary embodiment, a positioning mechanism (11), such as a pivot member or a pen, allows the weight-bearing member (10) to fold or retract when desired. According to this exemplary embodiment, the positioning mechanism (11) is sufficiently strong to maintain the integrity of the main body (2) while not impairing the functionality of the weight-bearing member (10). Suitable positioning mechanisms (11) configured to allow for the relative rotation of the weight-bearing member (10) include, but are not limited to, hinges, pivots, flexible or elastic materials, locking mechanisms, gears, and struts.

Continuing with FIGS. 1A and 1B, a light source (13) is disposed in the weight-bearing member (10). According to the present exemplary system, the light source (13) is either partially or completely disposed in the weight-bearing member (10). According to one exemplary embodiment, the weight-bearing member (10) includes a recessed depression configured to receive the light source (13). The light source may be mechanically fixed in the formed recess by an interference fit, or alternatively, may be coupled to the weight-bearing member (10) by any number of fasteners, adhesives, or fits.

As mentioned, a light source (13) is disposed in the weight-bearing member (10). Suitable light sources (13) that may be disposed in the weight-bearing member (10) of the present exemplary system include, but are not limited to, light emitting diodes (LEDs), filament bulbs, halogen lamps, sodium vapor lamps, fluorescent lamps, light sticks, lasers, chemical processes, luminescent materials, and/or reflective materials.

Additionally, the present exemplary light source (13), as mentioned herein, may include additional components configured to facilitate the generation of light. For example, according to one exemplary embodiment, the present exemplary light source (13) may include any number of elements such as, but in no way limited to, a battery or activation chemicals. Additionally, a switch or other simple circuitry may be present on the exemplary light source (13) in order to provide a user with the ability to turn the exemplary light source on or off.

According to one exemplary embodiment, the present exemplary light source (13) is coupled to a weight-bearing member (10) having a thru orifice. According to this exemplary embodiment, the light source (13) is able to emit light from one or more surfaces of the system. According to this embodiment, a user is provided with aiding light as he/she goes up or down the exemplary system.

In another exemplary embodiment, the light source (13) is removable and can be inserted into a groove, notch, or cavity in the weight-bearing member (10) or on the surface of an element of the system. According to this exemplary embodiment, replacement of the light source (13) is facilitated, should the light source burn out or otherwise become depleted.

In another embodiment the light source (13) is completely detached from the system and shines on or near the system. According to this embodiment, the light shines up or down on the weight-bearing member (10), rather than through it.

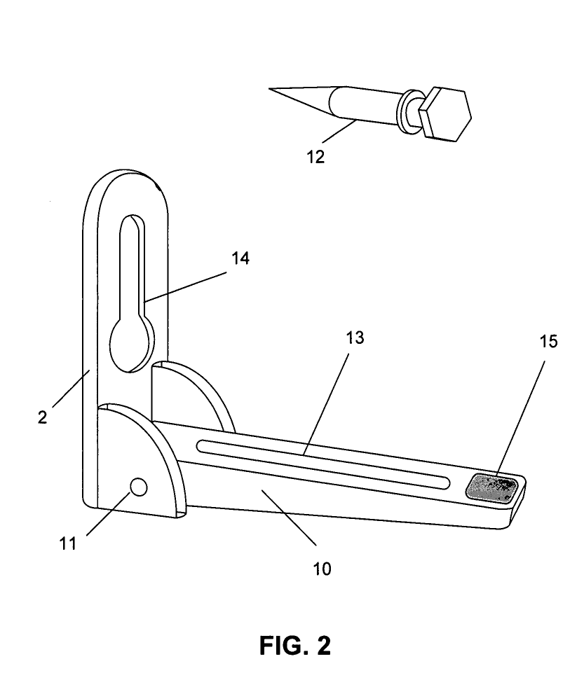

As depicted in FIG. 2, one exemplary embodiment includes a sensing element (15) such as a photoelectric cell, photodiode, phototransistor, charge coupled device (CCD), or other device capable of sensing conditions in the vicinity of the system such as electromagnetic emissions, movement, a lack of sun, or the presence of heat. The detection of a pre-determined condition, such as darkness, motion, or heat by the sensing element (15) will cause the light source (13) to either begin emitting light or stop emitting light, depending on the circuitry and settings of the exemplary operation. According to one exemplary embodiment, the sensing element (15) may be coupled directly to the main body (2) or be detached from the main body.

According to one exemplary embodiment, the sensing element (15) may include a remote control system including an RF transmitter and a corresponding receiver configured to receive RF signals corresponding to the RF transmitter. According to this exemplary embodiment, a user may locate and identify equipped trees or structures regardless of the light conditions.

Another embodiment of the present exemplary system includes a plurality of implementations of the system used in concert to form a larger system. The body of each implementation may be fastened or coupled to at least one shared support beam, object, or surface. The system resulting from the combination of several embodiments may also include traditional weight-bearing members (10). Such a system may establish a ladder where at least one weight-bearing member (10) is capable of being illuminated. As with other embodiments mentioned above, the light source (13) may be coupled to the main body (2), coupled to an object or surface, or detached from the main body. The composite system may be fastened to an object or surface with a fastener or support itself on the ground.

### Exemplary Method

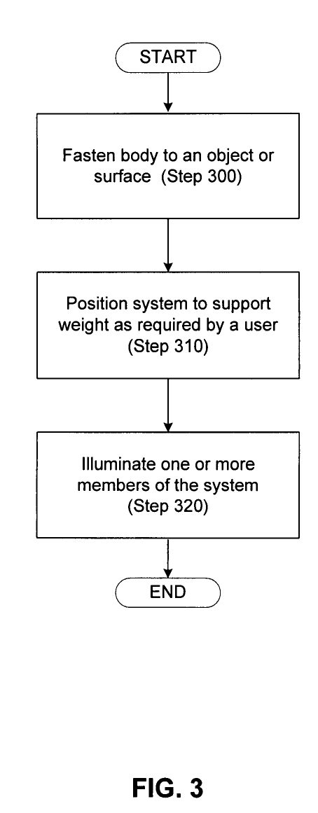

FIG. 3 illustrates an exemplary method for operating a lighted step system. According to the exemplary method illustrated in FIG. 3, the main body of the present exemplary system is fastened to a desired object or surface (step 300). As mentioned previously, the main body (2) may be fastened to a desired object or surface with a fastener (12) or other device.

Once the main body (2) is securely fastened to a desired object, the system may be positioned to support the weight of a user (step 310). Specifically, the weight-bearing member (10) may be rotated about the main body (2) such that it is substantially parallel to the ground below. Once rotated, the exemplary system is in position to be stepped upon and support the weight of a user ascending the desired object or surface.

Once in position for supporting a user, at least one element of the system is illuminated (step 320). As mentioned previously, the illumination of the light source (13) may be accomplished by electrical or chemical means, and may be activated by a switch or a remote. According to one exemplary embodiment, the illumination may continue for a set duration or indefinitely.

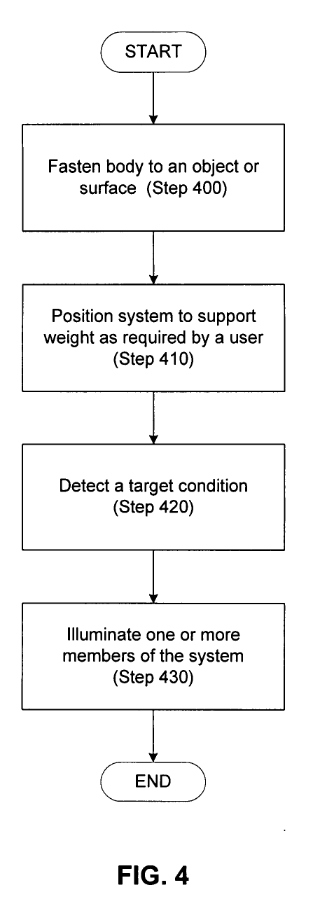

As depicted in FIG. 4, the illumination of the light source may occur automatically in response to an environmental condition, or in response to a detected condition. Specifically, as shown in FIG. 4, the main body of the present exemplary system is fastened to a desired object or surface (step 400). As mentioned previously, the main body (2) may be fastened to a desired object or surface with a fastener (12) or other device. Once the main body (2) is securely fastened to a desired object, the system may be positioned to support the weight of a user (step 410). When in position, the system may then be left alone until a previously identified condition is detected (step 420). Once detected, the sensor (15) can complete a circuit and illuminate a light source (13).

In conclusion, the above-mentioned example illustrates several embodiments of a lighted step and exemplary methods of operation of the system. More specifically, the present exemplary system and method for lighted steps has been shown to provide support while illuminating a path formed by embodiments of the system.

While the present exemplary system is illustrated and described in the context of a light source being coupled to a weight-bearing member by a groove or other coupling device formed in the weight-bearing member. However, the present exemplary system and method may also be used to retrofit an existing tree-step for a light source through the use of any number of light coupling devices including, but in no way limited to, adhesives, grooves, and/or mechanical coupling members.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. A tree-step system, comprising:
a fastener configured to be coupled to a vertical member; and
a step component including a body, a weight-bearing member coupled to said body, and a light source associated with said weight-bearing member;
wherein said light source indicates a location of said weight-bearing member.

2. The system of claim 1, further comprising a connection interface between said fastener and said body, wherein said connection interface is configured to provide a removable coupling between said fastener and said body.

3. The system of claim 1, further comprising a pivoting member disposed between said body and said weight-bearing member, said pivoting member being configured to allow said weight-bearing member to pivot relative to said body.

4. The system of claim 1, wherein said light source is coupled to said body.

5. The system of claim 1, wherein said light source is coupled to said weight-bearing member.

6. The system of claim 1, wherein said light source is detached from said step component.

7. The system of claim 1, further comprising a sensor associated with said light source;
wherein said sensor is configured to activate or de-activate said light source when a pre-determined condition is sensed.

8. The system of claim 7, further comprising:
a radio-frequency (RF) transmitter; and
an RF sensor coupled to said light source;
wherein said RF transmitter is configured to receive signals from said RF transmitter and to activate or de-activate said light source when said RF signal is received.

9. The system of claim 7, wherein said sensor comprises a weight sensor configured to detect a weight of a user and to activate said light source when said weight of a user is detected

10. The system of claim 1, wherein said weight-bearing member comprises an outer member defining an orifice configured to house said light source.

11. The system of claim 10, wherein said orifice is defined completely through said outer member.

12. A tree-step system, comprising:
a fastener configured to be coupled to a vertical member;
a step component including a body defining a keyhole orifice configured to receive said fastener, a weight-bearing member pivotably coupled to said body, and a light source coupled to said step component; and
a sensor associated with said light source, wherein said sensor is configured to activate or de-activate said light source when a pre-determined condition is sensed.
said light source being configured to indicate a location of said weight-bearing member.

13. The system of claim 12, further comprising a pivoting member disposed between said body and said weight-bearing member, said pivoting member being configured to allow said weight-bearing member to pivot relative to said body.

14. The system of claim 12, wherein said light source is coupled to said body.

15. The system of claim 12, wherein said light source is coupled to said weight-bearing member.

16. The system of claim 12, further comprising:
a radio-frequency (RF) transmitter; and
an RF sensor coupled to said light source;
wherein said RF transmitter is configured to receive signals from said RF transmitter and to activate or de-activate said light source when said RF signal is received.

17. The system of claim 12, wherein said sensor comprises a weight sensor configured to detect a weight of a user and to activate said light source when said weight of a user is detected

18. The system of claim 1, wherein said weight-bearing member comprises an outer member defining an orifice configured to house said light source.

19. The system of claim 10, wherein said light source comprises at least one of a light emitting diode (LED), a filament bulb, a halogen lamp, a sodium vapor lamp, a fluorescent lamp, a light stick, a chemical process, a luminescent material, or a laser.

20. A method of illuminating a tree-step, comprising:
fastening said tree-step to an object or surface;
inserting at least one light source in said tree-step; and
illuminating at least one of said light sources.
